(19) United States
(12) Patent Application Publication
(10) Pub. No.: US 2014/0359731 A1
(43) Pub. Date: Dec. 4, 2014

(54) ESTABLISHING COMMUNICATIONS SESSIONS OVER MULTIPLE NETWORK PROTOCOLS USING A STORED KEY

(71) Applicant: QUALCOMM Incorporated, San Diego, CA (US)

(72) Inventors: Alexander Gantman, Yokneam (IL); Yossef Tsfati, Rishon Le-Zion (IL)

(73) Assignee: QUALCOMM Incorporated, San Diego, CA (US)

(21) Appl. No.: 13/905,108

(22) Filed: May 29, 2013

(51) Int. Cl. H04L 29/06

(52) U.S. Cl. CPC H04L 63/08
USPC 726/6

(57) ABSTRACT

Systems and methods are provided for establishing communications sessions over multiple network protocols using a stored key. The key may be generated by a user credential entered at a first network station and may be stored in a profile in a memory of the first network station and used for authenticating with a second network station to establish a communications session with the second network station over a first network protocol. The key may then be retrieved from the profile for use in authenticating with the second network station and establishing a communications session with the second network station over a second network protocol.

### TECHNICAL FIELD

Embodiments disclosed herein are generally directed to establishing communications sessions over multiple network protocols using a stored key.

### BACKGROUND

With the increase of portable computing devices, it is desirable for networks, both wired and wireless, to be faster, more reliable, and wider ranged. Each technology has certain limitations and advantages. For example, the IEEE 802.11ad wireless network protocol (WiGig™) has a maximum throughput of about 7 Gbit/s, but has a very limited range. The IEEE 802.11n wireless network protocol, on the other hand, provides a good range, but has a limited throughput of only about 54 Mbit/s to 600 Mbit/s. To attempt to maximize speed and range of wireless communications, wireless network stations may include multiple wireless transceivers for communicating according to multiple wireless network protocols. For example, in order to compensate for the limited range of the 802.11 ad wireless network protocol, a network station that includes a wireless transceiver for communicating according to the 802.11 ad wireless network protocol may also include a wireless transceiver for communicating according to the 802.11n wireless network protocol, and potentially additional wireless transceivers for communicating according to additional wireless network protocols.

When a first network station having multiple wireless transceivers is in communication with a second network station also having multiple wireless transceivers in a point-to-point connection, the multiple wireless transceivers in each station may have separate, different, media access control (MAC) addresses and, due to operating system limitations in current networking protocol, may require establishing separate communications sessions. Moreover, establishing the separate communications sessions may each require a user at one of the network stations to separately enter credentials to establish each session. The need to separately enter the credentials for each session may be time consuming and frustrating to a user.

What is needed are systems and methods for establishing communications sessions over multiple network protocols using a stored key that replaces the need to enter credentials for each session.

### SUMMARY

Various methods, systems, devices, and apparatuses are described for establishing multiple communication sessions over multiple network protocols using a stored key. In one embodiment, a method may include receiving, at a first network station, a credential; generating a key, at the first network station, using the credential; storing the generated key at the first network station; establishing a communications session with a second network station according to a first communications protocol using the generated key; and establishing a communications session with the second network station according to a second communications protocol using the stored key. In one embodiment, the method may be implemented in computer-readable media.

In some embodiments, a system may include a first network station configured to communicate over at least a first network protocol and a second network protocol and a second network station configured to communicate over at least the first network protocol and the second network protocol. The first network station may further be configured to receive a credential, establish a communications session with the second network station according to the first network protocol using a key generated by the received credential, store the generated key, and establish a communications session with the second network station according to the second network protocol using the stored key.

### BRIEF DESCRIPTION OF THE DRAWINGS

FIG. 1 is a diagram illustrating two network stations in communication over multiple network protocols.

FIG. 2 is a diagram illustrating two network stations in communication over multiple network protocols, consistent with some embodiments of this disclosure.

FIG. 3 is a diagram illustrating a network station, consistent with some embodiments.

FIG. 4 is a diagram illustrating a first network station establishing communications sessions with a second network station over a first protocol and a second protocol, according to some embodiments.

FIG. 5 is a flowchart illustrating a process for establishing communication sessions in accordance with different protocols between network stations using a common key generated from an entered credential, according to some embodiments.

FIG. 6 is a flowchart illustrating a process for establishing communications sessions over a first network protocol and a second network protocol using a common key generated from an entered credential, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope of this disclosure.

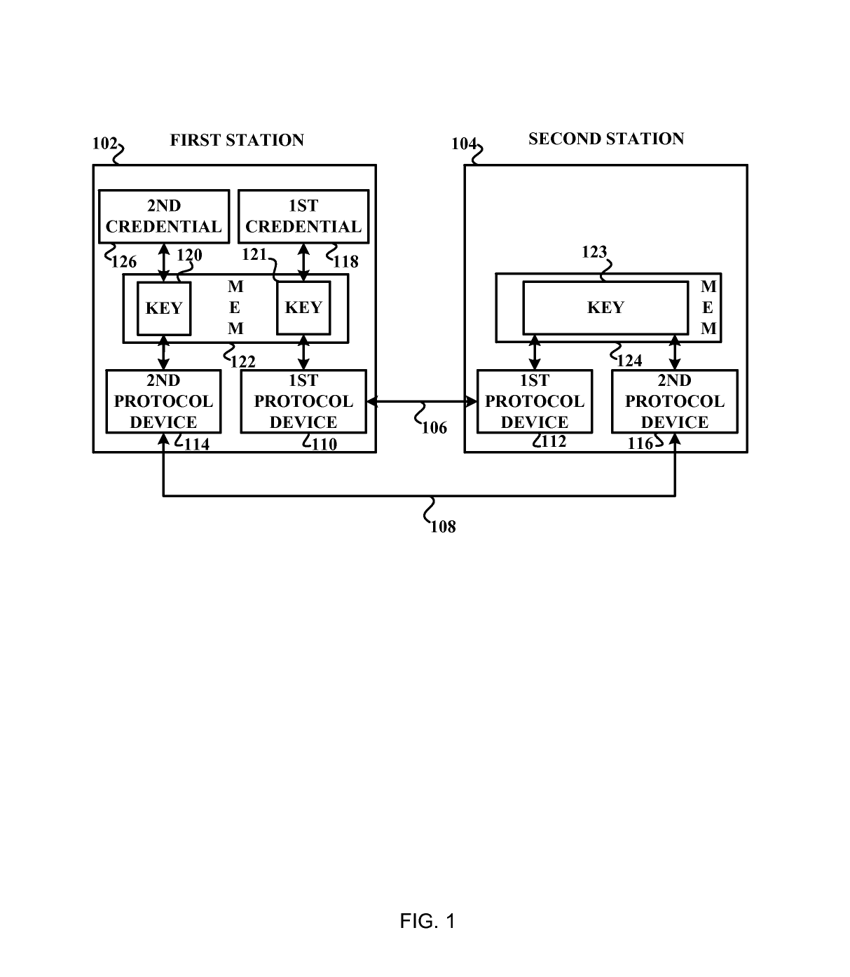

FIG. 1 is a diagram illustrating two network stations in communication over multiple network protocols. As shown in FIG. 1, a first network station 102 may be in communication with a second network station 104 according to a first network protocol 106 and a second network protocol 108. Communications according to first network protocol 106 may be enabled by devices 110 and 112 in first network station 102 and second network station 104, respectively, configured to communicate according to first network protocol 106. Similarly, communications according to second network protocol 108 may be enabled by devices 114 and 116 in first network station 102 and second network station 104, respectively, configured to communicate according to second network protocol 108. First and second network protocols 106 and 108 may be wireless network protocols, for example, network protocols specified by the Institute of Electrical and Electronic Engineers (IEEE) 802.11 specification. First and second network protocols 106 and 108 may also be wired network protocols, such as specified by the IEEE 802.3 specification. Moreover, first and second network protocols 106 and 108 may also include one wireless network protocol and one wired network protocol.

First network station 102 and second network station 104 may be capable of securely communicating with each other and other network stations using a security specification such as IEEE 802.1X, Wired Equivalent Privacy (WEP), Wi-Fi Protected Access (WPA), WPA2 (also called RSN (Robust Security Network)), and other such security specifications. Secure communications according to one of these security specifications may require that one network station, referred to as a supplicant, authenticate with another network station, referred to as the authenticator, before a communications session can be established and information can be securely transmitted between network stations such as first network station 102 and second network station 104. The authentication may require the entry of one or more credentials that may be used during the authentication. For example, a user at first network station 102 may be required to enter a first credential 118 to establish a communications session with second network station 104 over first protocol 106. First credential 118 may then be used to generate a key 120, which may be stored in a memory 122 of first network station 102. Key 120, based on first credential 118 may be used for authenticating first network station 104 with second network station 104 to establish a communication session over first protocol 106 and allow for the secure communication of information between first network station 102 and second network station 104. In one embodiment, second network station 104 may also use a key 123 stored in a memory 124 and based on a credential entered by a user of second network station for authenticating with first network station 102, thereby providing dual authentication between the two network stations. A user of first network station 102 may be required to enter a second credential 126 that may be used to generate a second key, such as key 121, which may be used to authenticate with second network station 104 to establish a communication session over second protocol 108.

As shown in FIG. 1, a user at the first network station may have to enter two separate credentials, or the same credential twice in order to establish communication sessions according to both first communication protocol 106 and second communication protocol 108. In some embodiments, first credential 118 and second credential 126 may be the same credential and may generate the same key. However, a user at first network station 102 may still be required to enter the same credential twice in order to authenticate with second network station 104 to establish a communication session over first network protocol 106 and a second communication session over second network protocol 108. As discussed previously, this may be frustrating and time consuming for a user.

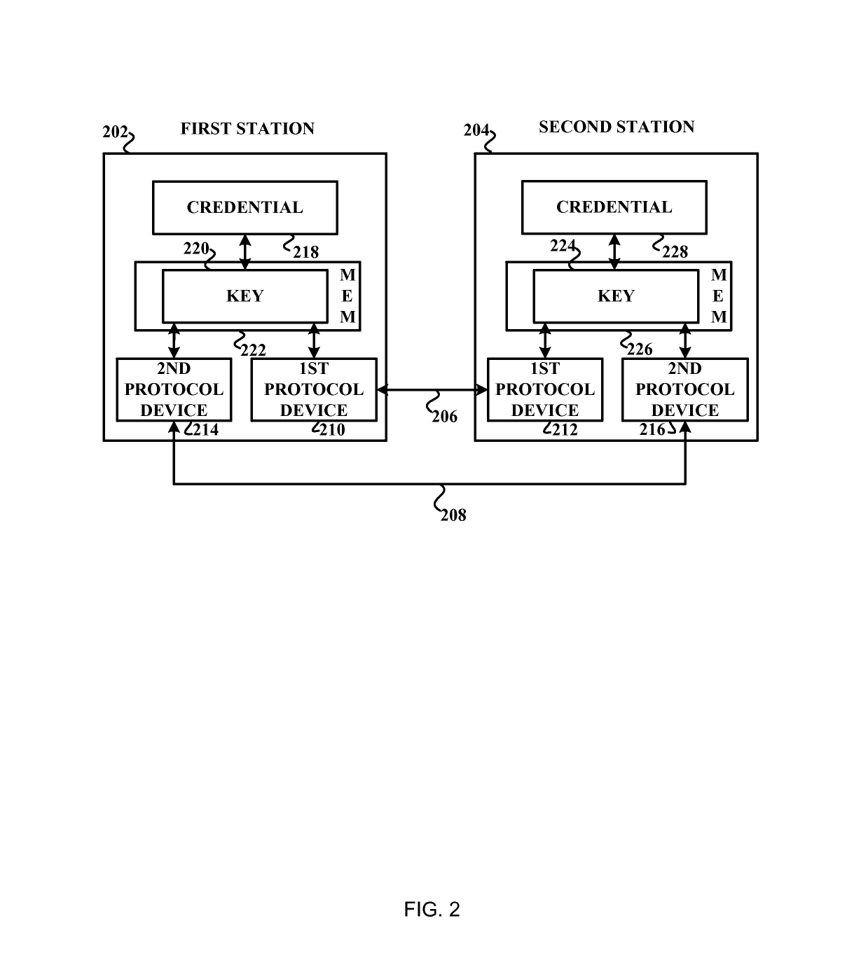

FIG. 2 is a diagram illustrating two network stations in communication over multiple network protocols, in accordance with some embodiments of this disclosure. As shown in FIG. 2, a first network station 202 may be capable of communicating with a second network station 204 according to a first network protocol 206 and a second network protocol 208. First and second network device 202 and 204 may be capable of secure communications based on one or more security specifications. Communications according to first network protocol 206 may be enabled by devices 210 and 212 in first network station 202 and second network station 204, respectively, configured to communicate according to first network protocol 206. Similarly, communications according to second network protocol 208 may be enabled by devices 214 and 216 in first network station 202 and second network station 204, respectively, configured to communicate according to second network protocol 208. First and second network protocols 206 and 208 may be wireless network protocols, for example, network protocols specified by the Institute of Electrical and Electronic Engineers (IEEE) 802.11 specification. In some embodiments, first network protocol 206 may correspond to the IEEE 802.11n wireless networking protocol, and second network protocol may correspond to the IEEE 802.11ad wireless networking protocol.

To establish a communication session with second station 204 over first protocol 206, a user at first network station 202 may be required to enter a credential 218. Credential 218 may be a password or a personal identification number (PIN) that is entered by a user of first network station 202. According to other embodiments, credential 218 may be a biometric credential, a credential corresponding to or represented by a Quick Response (QR) code, a data file including a credential such as may be stored on a key card, a smart card, or a USB drive, or other type of credential.

Credential 218 may then be used to generate a key 220, which may be stored in a memory 222 of first network station 202. In some embodiments, credential 218 may be used along with, among other things, a Media Access Control (MAC) address of first network station 202 and/or second network station 204 to generate key 220. In some embodiments, key 220 may be a Pairwise Master Key (PMK) that may be used in a robust security network association (RSNA) authentication procedure for authenticating first network station 202 with second network station 204 to establish a communications session. RSNA Authentication is an association between stations that includes a 4-way handshake and the generation of a group key used to decrypt information transmitted between the stations.

In some embodiments, key 220 may be stored in a profile in memory 222. Key 220 may be stored in the profile in memory 222 as either an encrypted key or an unencrypted key. Key 220 may then be used for authenticating first network station 202 with second network station 204. In some embodiments, key 220 may be used to generate another key that is used for authentication. For example, key 220 may be used to generate a groupwise master or temporary key that may be shared between members of a group, such as first station 202 and second station 204. Similarly, second station 204 may also include a key 224 stored in memory 226 that may be used for authentication with first network station 202. In some embodiments, key 224 may also be generated by a credential 228 entered by a user of second network station 204 and stored in a profile in memory 226. In general, key 224 may be similar in function and capabilities as key 220 and will not be discussed separately. When first network station 202 has authenticated with second network station 204 over first network protocol 206 using key 220 for authentication, and/or second network station 204 has authenticated with first network station 202 using key 224 for authentication, a communications session over first network protocol 206 may then be established.

In some embodiments, key 220 may be stored in a profile in memory 222 by a service of an operating system of first station 202, and key 220 may be stored in the profile in memory 222 for a duration of an operating system session. That is, key 220 may be deleted from memory 222 once the operating system session stops executing, for example when first station 202 is powered down. However, in some embodiments, key 220 may persist in memory 222 for a duration that exceeds an operating system session. The duration may be specified by a network administrator or a user or may be dynamically assigned. For example, a network administrator may specify a duration that adheres to an enterprise security protocol, which may be eight hours, such that a user is required to enter credential 218 to generate key 220 every eight hours. As another example, the duration may be assigned by a user based on a desired time in which the user does not want to re-enter credential 218 to generate key 220. As a further example, the duration may be dynamically assigned by second network station 204 as part of the authentication based on a security profile associated with second network station 204 or a network that first network station 202 and second network station are part of, or based on the network protocol over which first network station 202 and second network station 204 are establishing communications.

According to some embodiments, to establish a communication session with second network station 204 using second protocol 208, key 220 may be retrieved from the profile in memory 222 and used for authenticating first network station 202 with second network station 204 to establish the communication session. In some embodiments, key 220 may be used to generate another key that is used for authentication with second station 204. A communications session over second network protocol 208 may then be established without a user at first network station 202 needing to enter credential 218 a second time. In some embodiments, network stations 202 and 204 may switch from communications over first protocol 206 and second protocol 208 using Fast Session Transfer (FST) as specified by the IEEE 802.11 standard. Moreover, in some embodiments, key 220 may be retrieved from a profile in memory 222 before connecting with device 216 of second network station 204. In some embodiments, key 220 may be retrieved from the profile in memory as it is stored in memory 222 before communications have been initiated over second protocol 208 or another protocol and stored in a temporary memory, such as a buffer, such that key 220 can be retrieved when communications are initiated over second protocol 208 or another protocol to establish a communications session.

Although FIG. 2 illustrates retrieving key 220 stored in a profile in memory 222 for establishing a communications session with second station 204 over second protocol 208 without needing to enter a second credential, in some embodiments additional communications sessions with other network stations and/or over additional network protocols may be established using key 220 without requiring a user to enter additional credentials.

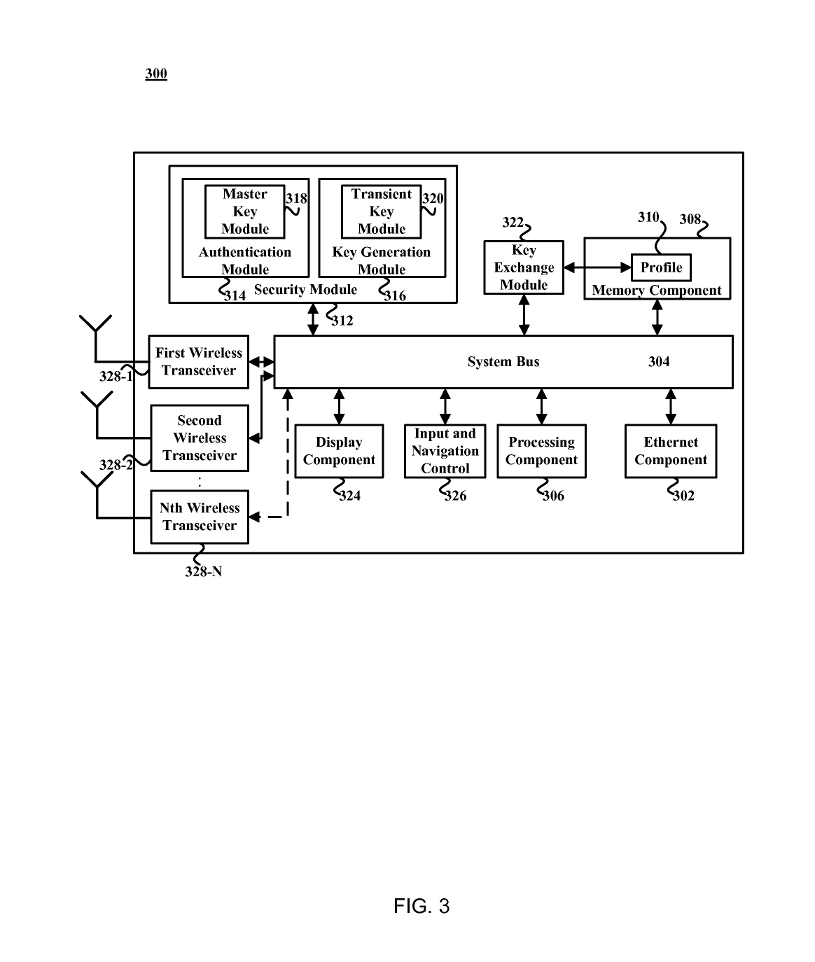

FIG. 3 is a diagram illustrating a network station, consistent with some embodiments. Network station 300 may correspond to either of first network station 202 or second network station 204 shown in FIG. 2. Network station 300 may include an optional Ethernet component 302 configured for wired communication for direct communication with another network station. Consistent with other embodiments, Ethernet component 302 may be configured to interface with a coaxial cable, a fiber optic cable, a digital subscriber line (DSL) modem, a public switched telephone network (PSTN) modem, an Ethernet device, and/or various other types of wired network communication devices. Consistent with some embodiments, network station 300 includes a system bus 304 for interconnecting various components within network station 300 and communicating information between the various components. Such components include a processing component 306, which may be one or more processors, micro-controllers, or digital signal processors (DSP), audio processors or graphics processors. Such components also include a memory component 308. Memory component 308 may correspond to random access memory (RAM), read only memory (ROM), optical, magnetic, or solid-state memories. Memory component 308 may include a profile 310 that may be created by an operating system of network station 300 upon establishing a communications session resulting from a successful authentication with another network station, such as shown in FIG. 2.

Network station 300 may also include one or more modules. In some embodiments, the modules may be software modules that perform a function when executed by processing component 306. In other embodiments, the modules may refer to an Application Specific Integrated Circuit (ASIC) or other circuit having memory and at least one processor for executing instructions to perform a function. The modules may include a security module 312 configured to manage the security of information transmitted and received by station 300 over a network. Security module 312 may include an authentication module 314 and a key generation module 316. In some embodiments, authentication module 314 may be configured to authenticate communications of station 300. In some embodiments, authentication module 314 may be configured to perform RSNA authentication that includes a 4-way handshake and the generation of a group key used to decrypt information transmitted between the stations.

Authentication module 314 may include a master key module 318 that may be configured to obtain or generate a master key, such as a pairwise master key (PMK) for use during a communications session. In some embodiments, the generated PMK may be stored in profile 310 in memory component 308. Moreover, master key module 318 may be configured to generate the PMK based on a credential entered by a user of network station 300. Key generation module 316 may be configured to generate keys used for encrypting information transmitted by station 300. Key generation module 316 may include a transient key module 320 configured to generate a pairwise transient key (PTK) based on the PMK. In some embodiments, transient key module 320 generates a PTK from a PMK using a random or pseudo-random function. Station 300 may also include a key exchange module 322. Key exchange module 322 may be configured to read the PMK stored in profile 310 and provide it for use in a subsequent authentication session. In some embodiments, key exchange module 322 may read the PMK stored in profile 310 and provide the PMK to security module 312 for use in an RSNA authentication or other authentication techniques with a second network station, or the same network station over a different network protocol.

In some embodiments, since profile 310 may be created by an operating system of network station 300, profile 310 may persist only as long as an operating system session is active. In some embodiments, profile 310 may be viewable and accessible by a user of network station 300. For example, an operating system of network station 300 may include operating systems such as Microsoft® Windows®operating systems or Apple® MacOS™ operating systems. In such operating systems, read access privileges of profile 310 may be kept for an operation or application that creates profile 310, such as an authentication with another network station performed, in part, by security module 312. Moreover, profile 310 may only persist for the same user for whom the operation or application created profile 310. Consequently, in some embodiments, key exchange module 322 may be configured to read the PMK stored in profile 310 as it is stored in profile 322 for use when network station 300 begins communicating with another network station that requires an additional and separate authentication for establishing a communications session.

Consistent with some embodiments, network station 300 may optionally include a display component 324 for displaying information to a user. Display component 324 may be a liquid crystal display (LCD) screen, an organic light emitting diode (OLED) screen (including active matrix AMOLED screens), an LED screen, a plasma display, or a cathode ray tube (CRT) display. Network station 300 may also include an optional input and navigation control component 326, allowing for a user to input information and navigate along display component 324. An input and navigation control component 326 may include, for example, a keyboard or key pad, whether physical or virtual, a mouse, a trackball, or other such device, or a capacitive sensor based touch screen.

Network station 300 may also include one or more wireless transceivers, such as first wireless transceiver 328-1 and second wireless transceiver 328-2. Network station 300 may include N wireless transceivers 328-N, wherein each wireless transceiver may include an antenna that is separable or integral and is capable of transmitting and receiving information according to a different wireless network protocol, such as Wi-Fi™, 3G, 4G, HDSPA, LTE, RF, NFC, IEEE 802.11a, b, g, n, ac, or ad, Bluetooth®, WiMAX, ZigBee®, etc. According to some embodiments, first wireless transceiver 328-1 may transmit and receive information according to the IEEE 802.11n wireless network protocol, and second wireless transceiver 328-2 may transmit and receive information according to the IEEE 802.11 ad wireless network protocol. In some embodiments, first wireless transceiver 328-1 may correspond to first device 210 or 212 shown in FIG. 2, and second wireless transceiver 328-2 may correspond to second device 214 or 216. According to some embodiments, N wireless transceivers 328-N may be implemented using the same hardware but with different drivers for each wireless network protocol. The drivers may be stored in memory component 308 and be executed by one or more processors of processing component 306.

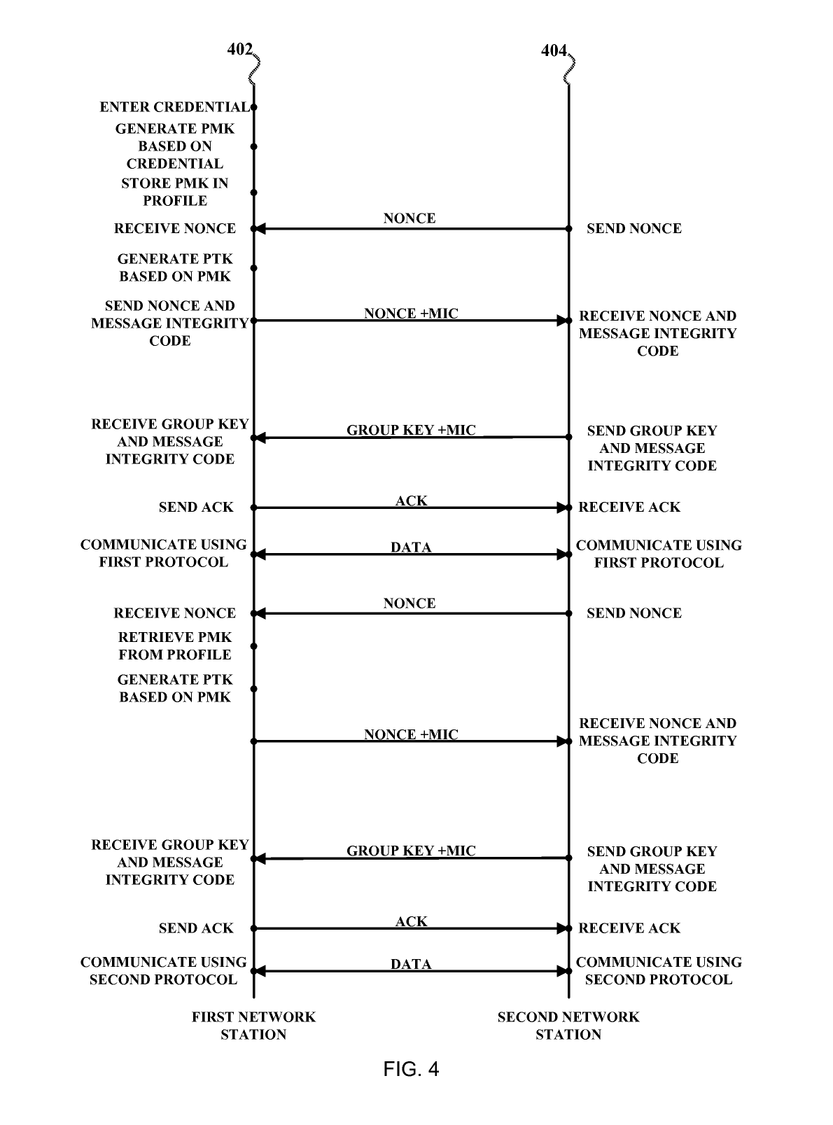

FIG. 4 is a diagram illustrating a first network station establishing a communications session with a second network station over a first protocol and a second protocol, consistent with some embodiments. First network station 402 and second network station 404 may correspond to network station 300 shown in FIG. 3 and, thus, reference may be made to FIG. 3. Although the events shown in FIG. 4 primarily describe the events that occur at first network station as it authenticates second network station 404, similar events could occur at second network station 404 as it authenticates first network station 402. As shown in FIG. 4, a user at first network station 402 may enter a credential. Based, at least in part, on the entered credential, master key module 318 may generate a PMK and store the PMK in profile 310 in memory component 308. Second network station 404 may then send a nonce to first network station 402 to begin establishing a communications session over a first protocol. Transient key module 320 may then generate a pairwise transient key (PTK) based, at least in part, on the PMK. In some embodiments, the PTK may also be generated based on the nonce received from second network station 404, a MAC address of second network station 404, a MAC address of first network station, and PMK. In some embodiments, the PTK may be generated by concatenating these attributes and values. The PTK may be used to encrypt traffic to and from first network station 402 and second network station 404.

After first network station 402 has generated the PTK, first network station 402 may send a nonce to second network station 404. The nonce may also include a message integrity code, in some embodiments and may be generated using the PTK. Second network station 404 may then receive the nonce from first network station 402 along with the message integrity code. Second network station 404 may then send a group key plus a message integrity code to first network station. In some embodiments, the group key may be a groupwise transient key generated from a groupwise master key. The group key may be used in encrypting broadcast and multicast traffic between first network station 402 and second network station 404. First network station 402 may then send an acknowledgement message (ACK) after receiving the group key and message integrity code. The process of exchanging nonce, the group key, and an ACK may be the 4-way handshake used in RSNA authentication. Once first network station 402 has authenticated with second network station 404, the communications session between first network station 402 and second network station 404 may be established and data may be communicated between first network station 402 and second network station 404 over the first network protocol.

When communications over a second network protocol become available, the same 4-way handshake may be performed between first network station 402 and second network station 404 to authenticate first network station 402 with second network station 404 over the second network protocol and allow for first network station 402 and second network station 404 to establish a communications session for the communication of data over the second network protocol. However, when performing the authentication, key exchange module 322 may retrieve PMK from profile 310 in memory component 308 for use in generating the PTK. As a result, a user of first network station 402 will not have to enter another credential to generate a PMK for authentication. Although this embodiment refers to a security protocol and technique that uses a 4-way handshake as part of an authentication, other security protocols may benefit from using key exchange module 322 to retrieve a key generated for a first authentication to use for subsequent authentications.

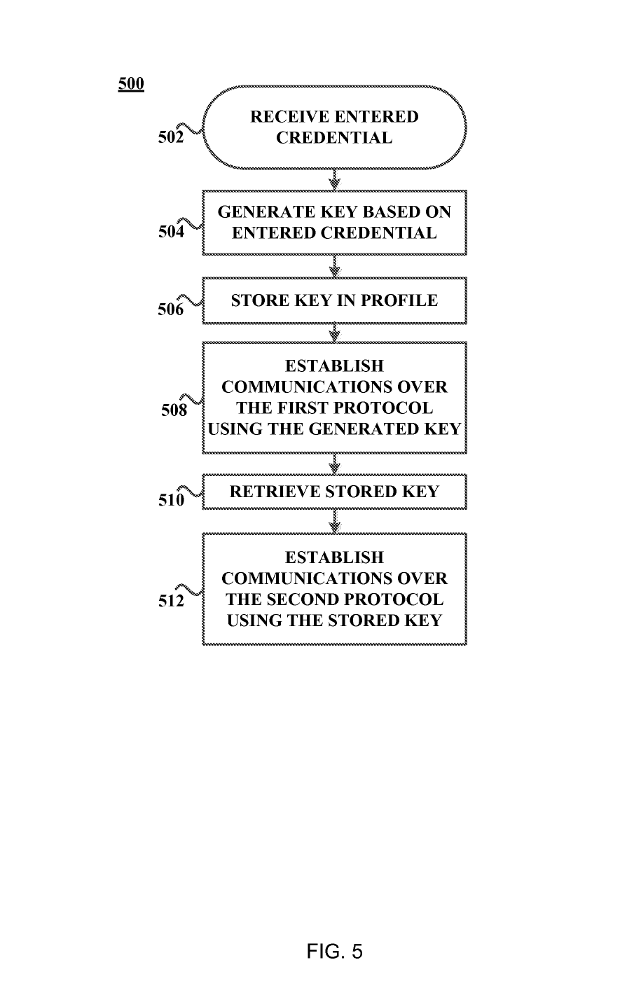

FIG. 5 is a flowchart illustrating a process for establishing communications sessions over a first network protocol and a second network protocol using a common key generated from an entered credential, consistent with some embodiments. The process 500 shown in FIG. 5 may be embodied in computer-readable instructions for execution by one or more processors in processing component 306 of network station 300 or by one or more modules, such as security module 312 and key exchange module 322. In some embodiments, process 500 may be implemented by an operating system of network station 300 and may be implemented as a background service in the operating system. As shown in FIG. 5, process 500 begins when network station 300 receives a user credential (502). In some embodiments the credential may be a password or a personal identification number (PIN), a biometric credential, a credential corresponding to or represented by a Quick Response (QR) code, a data file including a credential such as may be stored on a key card, a smart card, or a USB drive, or other type of credential. In some embodiments, the credential may be entered using input and navigation control component 326 of network station 300.

Based, at least in part, on the entered credential, a key may be generated (504). In some embodiments, the generated key may be a PMK generated by master key module 318. The generated key may then be stored in profile 310 (506). In some embodiments, the profile 310 may be created by the operating system and it may be user and session specific, such that it is available during the session in which it was created. Network station 300 may then authenticate with the other network station to establish a communications session over a first protocol using, in part, the generated key (508). The first protocol may be a wireless network protocol, including an 802.11 wireless protocol. In some embodiments, the generated key may be used to generate a transient key that may be used to authenticate with the other network station. Key exchange module 322 of network station 300 may then retrieve the generated key stored in profile 310 of memory 308 (510) and use the retrieved key to authenticate with the other network station to establish a communications session over the second protocol (512). The second protocol may also be a wireless network protocol, including an 802.11 wireless protocol. In some embodiments, key exchange module 322 may retrieve the generated key stored in profile 310 of memory 308 before receiving a request to authenticate with the other network station to establish a communications session according to a second protocol and store the retrieved key in a local memory, a temporary storage, or a buffer, in order to have it available if communications over a second protocol become available. Moreover, in some embodiments, switching from communications over a first protocol to a second protocol may be performed using Fast Session Transfer (FST) as specified by the IEEE 802.11 standard.

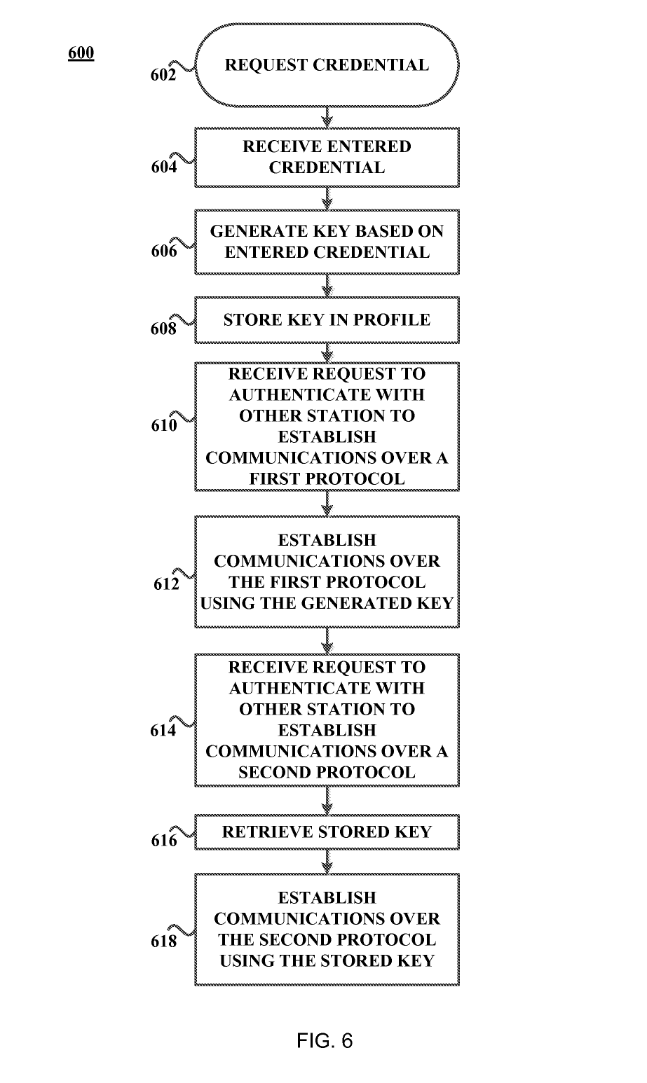

FIG. 6 is a flowchart illustrating a process for establishing communications sessions over a first network protocol and a second network protocol using a common key generated from an entered credential, consistent with some embodiments. The process 600 shown in FIG. 6 may be embodied in computer-readable instructions for execution by one or more processors in processing component 306 of network station 300 or by one or more modules, such as security module 312 and key exchange module 322. In some embodiments, process 600 may be implemented by an operating system of network station 300 and may be implemented as a background service in the operating system. As shown in FIG. 6, process 600 begins by requesting a credential (602). In some embodiments, the credential may be requested by displaying a prompt on display component 324 of network station 300. A user at network station 300 may then enter a credential that may be received by network station 300 (604). In some embodiments the credential may be a password or a personal identification number (PIN), a biometric credential, a credential corresponding to or represented by a Quick Response (QR) code, a data file including a credential such as may be stored on a key card, a smart card, or a USB drive, or other type of credential. In some embodiments, the credential may be entered using input and navigation control component 326 of network station 300.

Based, at least in part, on the entered credential, a key may be generated (606). In some embodiments, the generated key may be a PMK generated by master key module 318. The generated key may then be stored in profile 310 (608). In some embodiments, the profile 310 may be created by the operating system and it may be user and session specific, such that it is available during the session in which it was created. A request to authenticate with another network station to establish a communications session over a first protocol may then be received from the other network station (610). The first protocol may be a wireless network protocol, including an 802.11 wireless protocol. Network station 300 may then authenticate with the other network station to establish a communications session over a first protocol using, in part, the generated key (612). In some embodiments, the generated key may be used to generate a transient key that may be used to authenticate with the other network station. Network station 300 may then receive a request to authenticate with the other network station to establish a communications session over a second protocol from the other network station (614). The second protocol may also be a wireless network protocol, including an 802.11 wireless protocol. Key exchange module 322 of network station 300 may then retrieve the generated key stored in profile 310 of memory 308 (616) and use the retrieved key to authenticate with the other network station to establish a communications session over the second protocol (618). In some embodiments, key exchange module 322 may retrieve the generated key stored in profile 310 of memory 308 before receiving a request to authenticate with the other network station to establish communications according to a second protocol and store the retrieved key in a local memory, a temporary storage, or a buffer, in order to have it available if communications over a second protocol become available. Moreover, in some embodiments, switching from communications over a first protocol to a second protocol may be performed using Fast Session Transfer (FST) as specified by the IEEE 802.11 standard.

Software, in accordance with the present disclosure, such as program code and/or data, may be stored on one or more machine readable mediums, including non-transitory machine readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Consequently, embodiments as described herein may allow for establishing communications sessions between a first network station and a second network station over multiple protocols by authenticating using a stored key. The key may be generated by a user-supplied credential. By reusing the stored key for subsequent authentications, a user at the first network station may not be required to enter an addition credential or re-enter a credential to establish communications sessions over additional protocols, providing convenience for the user and saving time for the user. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A method, comprising:
receiving, at a first network station, an entered credential;
generating, by one or more processors of the first network station, a key based on the entered credential;
storing, in a profile in a memory of the first network station, the generated key;
establishing a wireless communications session with a second network station according to a first wireless communications protocol using the generated key;
retrieving the stored key from the profile; and
establishing a wireless communications session with the second network station according to a second wireless communications protocol using the stored key.

2. The method of claim 1, further comprising establishing a wireless communications session with the second network station according to a third wireless communications protocol using the stored key.

3. The method of claim 1, wherein storing the generated key comprises storing the generated key in an unencrypted file in the profile of the memory.

4. The method of claim 1, wherein establishing a wireless communications session with a second network station according to a second wireless communications protocol using the generated key comprises:
generating a transient key using the stored key; and
authenticating with the second network station using the generated transient key.

5. The method of claim 4, wherein authenticating with the second network station using the generated key comprises completing a four-way handshake using the generated key.

6. The method of claim 1, wherein establishing a wireless communications session with a network station according to a first wireless communications protocol comprises establishing a wireless communications session according to at least one of an Institute of Electrical and Electronic Engineers (IEEE) 802.11n and 802.11ad wireless networking protocol.

7. The method of claim 1, wherein establishing a wireless communications session with a network station according to a second wireless communications protocol comprises establishing a wireless communications session according to at least one of an IEEE 802.11n and 802.11 ad wireless networking protocol.

8. The method of claim 1, wherein receiving an entered credential comprises receiving at least one of a password, a personal identification number (PIN), a biometric credential, a file including the credential, a random number, and credential corresponding to a Quick Response (QR) code.

9. The method of claim 1, wherein retrieving the stored key from the profile comprises retrieving the stored key from the profile as soon as it is stored in the profile in the memory.

10. The method of claim 1, wherein establishing a wireless communications session with a network station according to a second wireless communications protocol comprises establishing a wireless communications session using Fast Session Transfer.

11. The method of claim 1, further comprising:
receiving, at the first network station, a request to authenticate with the second network station to establish the wireless communications session over the first wireless communications protocol.

12. The method of claim 11, wherein receiving a request to authenticate comprises receiving a nonce from the second network station.

13. The method of claim 1, further comprising:
receiving, at the first network station, a request to authenticate with the second network station to establish the wireless communications session over the second wireless communications protocol.

14. A first network station, comprising:
a transceiver; and
a communication module configured to,
receive an entered credential;
generate a key based on the entered credential;
store the generated key;
establish a wireless communications session with a second network station according to a first wireless communications protocol using the generated key;
retrieve the stored key; and
establish a wireless communications session with the second network station according to a second wireless communications protocol using the stored key.

15. The first network station of claim 14, further comprising a memory, wherein the communication module is configured to store the generated key in a profile in the memory.

16. The first network station of claim 14, wherein the communication module is further configured to:
generate a transient key using the stored key; and
authenticate with the second network station using the generated transient key.

17. The first network station of claim 14, wherein the first network protocol comprises an Institute of Electrical and Electronic Engineers (IEEE) 802.11n wireless networking protocol and the second network protocol comprises an IEEE 802.11ad wireless networking protocol.

18. The first network station of claim 14, wherein the entered credential comprises at least one of a password, a personal identification number (PIN), a biometric credential, a file including the credential, a random number, and a credential corresponding to a Quick Response (QR) code.

19. The first network station of claim 15, wherein the communication module is further configured to retrieve the stored key from the profile in the memory as it is stored in the profile in the memory.

20. The first network station of claim 14, wherein the first network station is configured to establish communications sessions with the second network station according to the first network protocol and the second network protocol using Fast Session Transfer.

21. A system, comprising:
a first network station configured to communicate over at least a first network protocol and a second network protocol,
a second network station configured to communicate over at least the first network protocol and the second network protocol, wherein the first network station is further configured to:
receive a credential;
establish a communications session with the second network station according to the first network protocol using a key generated by the received credential;
store the generated key; and
establish a communications session with the second network station according to the second network protocol using the stored key.

22. The system of claim 21, wherein the first network station comprises a memory configured to store the key in a profile.

23. The system of claim 21, wherein the first network station is further configured to:
generate a transient key using the stored key; and
authenticate with the second network station using the generated transient key.

24. The system of claim 21, wherein the first network protocol comprises an Institute of Electrical and Electronic Engineers (IEEE) 802.11n wireless networking protocol and the second network protocol comprises an IEEE 802.11ad wireless networking protocol.

25. The system of claim 21, wherein the credential comprises at least one of a password, a personal identification number (PIN), a biometric credential, a file including the credential, a random number, and a credential corresponding to a Quick Response (QR) code.

26. The system of claim 22, wherein the first network station is further configured to retrieve the stored key from the profile in the memory as it is stored in the profile in the memory.

27. The system of claim 21, wherein the first network station is configured to establish communications sessions with the second network station according to the first network protocol and the second network protocol using Fast Session Transfer.

28. A computer-readable medium including instructions that, when executed by one or more processors of a first network station, cause the first network station to perform a method comprising:
receiving an entered credential;
generating a key based on the entered credential;
storing the generated key in a profile;
establishing a wireless communications session with a second network station according to a first wireless communications protocol using the generated key;
retrieving the stored key from the profile; and
establishing a wireless communications session with the second network station according to a second wireless communications protocol using the stored key.
